(19) United States
(12) Patent Application Publication
(10) Pub. No.: US 2019/0145461 A1
(43) Pub. Date: May 16, 2019

(54) METHOD FOR PRODUCING A TOOTHED SINTERED COMPONENT

(71) Applicant: Miba Sinter Austria GmbH, Laakirchen (AT)

(72) Inventors: Martin KARLSBERGER, Eberstalzell (AT); Wolfgang SIESSL, Traunkirchen (AT); Karl DICKINGER, Vorchdorf (AT)

(73) Assignee: Miba Sinter Austria GmbH, Laakirchen (AT)

(21) Appl. No.: 16/117,117

(22) Filed: Aug. 30, 2018

(30) Foreign Application Priority Data
Nov. 13, 2017 (AT) A 50948/2017

(51) Int. Cl. F16C 33/12; F16C 17/10; F16C 33/14

(52) U.S. Cl. CPC F16C 33/122; F16C 33/145; F16C 17/10

(57) ABSTRACT

The invention relates to a method for producing a toothed sintered component (1) according to which a green compact with a bearing mount (10) is pressed from a powder, the green compact is sintered and hardened and then at least one sliding bearing element is inserted into the bearing mount (10). The sliding bearing element is inserted into the bearing mount (10), which has a sintered-smooth surface (14), wherein a multi-layered sliding bearing element (11) is used as the sliding bearing element.

The invention relates to a method for producing a toothed sintered component, according to which a green compact with a bearing mount is pressed from a powder, the green compact is sintered and hardened and then at least one sliding bearing element is inserted into the bearing mount.

Furthermore, the invention relates to a sintered component comprising a main body which has a toothing and a bearing mount, wherein at least one sliding bearing element is arranged in the bearing mount.

In sintered gear wheels, which for support comprise a non-ferrous metal sliding bearing bush in a bearing mount, it has been usual until now to mechanically machine the surface of the bearing mount after hardening, in order to ensure a maximum tolerance of 30 μm. As a result of this, due to the hard surface of the bearing mount, the durability of the tools used is reduced. Furthermore, an additional step is required during manufacture for the machining.

The underlying objective of the present invention is to reduce the manufacturing costs of sintered gear wheels fitted with sliding bearings.

The objective of the invention is achieved by means of the aforementioned method, in which the sliding bearing element is inserted into a bearing mount which has a sintered-smooth surface, wherein a multi-layered sliding bearing element is used as the sliding bearing element.

Furthermore, the objective is achieved by means of the aforementioned sintered component, in that the bearing mount has a sintered-smooth surface and the sliding bearing element is a multi-layered sliding bearing element.

Surprisingly it was established that it is not necessary to smooth the surface of the bearing mount mechanically, and that said surface can be left sintered-smooth if a multi-layered sliding bearing element is used as the sliding bearing element. In this way tolerances of up to 60 μm can be allowed, whereby the production of the sintered component can be reduced by reducing the number of processing steps and tool wear accordingly. Such high tolerances have not previously been allowed, particularly as they result in relatively large irregularities of the internal contour.

To improve the bearing seat according to further embodiment variants it is possible that the sintered-smooth surface of the bearing mount, which is in direct contact with the multi-layered sliding bearing element, is produced to have an arithmetic average roughness value Rₐ according to DIN EN ISO 4287:2010 of at least 0.9 μm and a maximum of 2 μm and/or that the sintered-smooth surface of the bearing mount, which is in direct contact with the multi-layered sliding bearing element, is produced to have a surface roughness with an average roughness depth R_{z} according to DIN EN ISO 4287:2010 of at least 2 μm and a maximum of 30 μm and/or that the sintered-smooth surface of the bearing mount, which is in direct contact with the multi-layered sliding bearing element, is produced to have a surface roughness with a reduced center height Rₚₖ according to DIN EN ISO 13565:1998 and DIN ISO 23519:2015 of at least 0.1 μm and a maximum of 1.9 μm. In this way it is also possible to improve the pressing in of the sliding bearing element, as due to the roughness of the surface of the bearing mount the friction can be reduced when inserting the sliding bearing element.

It has also turned out to be advantageous in terms of the introduction of the multi-layered sliding bearing element into the bearing mount, if a multi-layered sliding bearing element is pressed in with a surface which is in direct contact with the surface of the bearing mount having an average roughness depth R_{z} according to DIN EN ISO 4287:2010 of at least 2 μm and a maximum of 30 μm. In addition, in some parts of the fitting after pressing in the multi-layered sliding bearing element a kind of “hooking” between the two surfaces can be achieved, whereby the bearing seat can be improved further. In this way the axial slipping of the multi-layered sliding bearing element can also be avoided more effectively.

According to a further embodiment variant, to improve the aforementioned effects the sintered component and a layer of the sliding bearing element, which is in direct contact with the bearing mount, are made from a metal material with the same base metal.

A further way to improve the introduction of the multi-layered sliding bearing element into the bearing mount is to provide the multi-layered sliding bearing element and/or the bearing mount with a lead-in chamfer.

For a better understanding of the invention the latter is explained in more detail with reference to the following Figures.

In a much simplified, schematic representation:

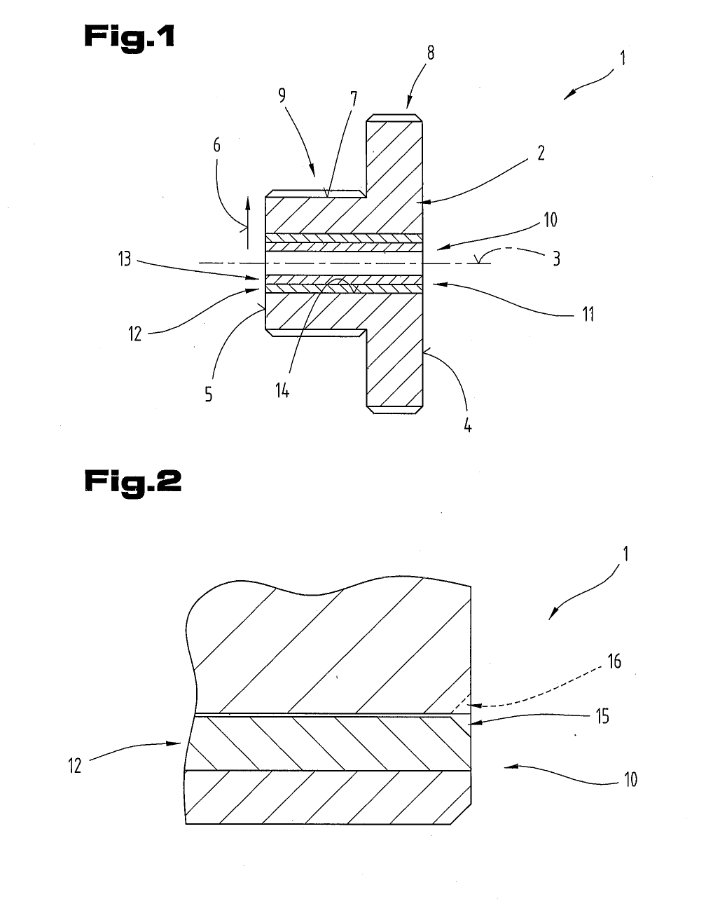

FIG. 1 shows a spur gear wheel in a cross-sectional side view;

FIG. 2 shows a section of a gear wheel in side view.

First of all, it should be noted that in the variously described exemplary embodiments the same parts have been given the same reference numerals and the same component names, whereby the disclosures contained throughout the entire description can be applied to the same parts with the same reference numerals and same component names. Also details relating to position used in the description, such as e.g. top, bottom, side etc. relate to the currently described and represented figure and in case of a change in position should be adjusted to the new position.

FIGS. 1 and 2 show an embodiment variant of a sintered component 1 in the form of a sintered gear wheel.

A sintered gear wheel is defined according to this description as a gear wheel which is produced according to a powder metallurgical method, i.e. according to a sintering method or is produced according to method which comprises powder metallurgical method steps.

Furthermore, a sintered gear wheel is defined as a gear wheel which is a gear wheel for a belt drive, i.e. a gear wheel which has at least one toothing for a chain drive and/or at least one toothing for a toothed belt drive, or is a gear wheel which is in meshing engagement with an additional gear wheel, i.e. a gear wheel for a gear wheel drive. The sintered gear wheel can also be designed to be used both for a belt drive and also for a gear wheel drive, if it has multiple tracks, as shown in FIG. 1.

The sintered component 1 comprises a main body 2. In axial direction 3 the main body 2 is delimited by a first axial end face 4 and a second axial end face 5 opposite the latter in axial direction. In radial direction 6 the wheel body is delimited by a peripheral surface 7 or casing surface. The peripheral surface 7 extends between the first axial end face 4 and the second axial end face 5. The peripheral surface 7 is represented as being stepped in the shown embodiment variant of the sintered component 1. However, it is also possible for the peripheral surface 7 to be designed not to have such a step.

On the peripheral surface 7 there is a first track with a first toothing 8, a second track is arranged next to the latter in axial direction 3 with a second toothing 9. The sintered component 1 can however also have only one toothing 8, 9 or more than two toothings 8, 9. The actual design and the number of respective toothings 8, 9 depends on the use of the sintered gear wheel 1.

Furthermore, in the main body 2 of the sintered component there is a continuous recess in axial direction 3 with an at least approximately circular cross-section, in particular a circular cross-section. Said recess forms a bearing mount 10 for at least one sliding bearing element, which is arranged in said bearing mount, in particular is pressed into the latter.

Instead of having a continuous recess it is also possible to provide a non-continuous recess in axial direction as the bearing mount 10, for example a blind bore.

The sliding bearing element is preferably a sliding bearing bushing. It is also possible to use sliding bearing half shells or sliding bearing shells with a circumferential extension of less than 180°.

The sliding bearing element is designed as a multi-layered sliding bearing element 11. Thus it comprises at least one first layer 12 and one second layer 13. The second layer 13 is arranged radially below the first layer 12 and is connected directly to the first layer. It thus forms the radial inner layer.

The first layer 12 forms a support layer, the second layer 13 forms a sliding layer for the sliding support of a shaft for example.

The multi-layered sliding bearing elements 11 can also comprise more than two layers, for example a bearing metal layer and/or a binding layer and/or a diffusion barrier layer between the first layer 12 and the second layer 13. Furthermore, a radially inward run-in layer can be provided on the second layer 13.

It is also possible that more than one multi-layered sliding bearing element 11 is provided arranged behind one another in axial direction 3, for example two multi-layered sliding bearing elements 11 which are spaced apart from one another if necessary in axial direction 3.

The sintered component 1 is produced by using a powder metallurgical method. As sintering technology is known from the prior art, reference is also made to the relevant prior art for further details.

To produce the sintered component 1 a metal powder us used. The metal powder can also be a powder mixture and also powder particles of a metal alloy can be used. In particular, a sintering steel powder or an iron-containing powder is used as the metal powder, as is known for the production of sintered components. Typical powder mixtures are for example:
Fe (prealloyed with 0.85 wt. % Mo)+0.1 wt. %−0.3 wt. % C+0.4 wt. %−1.0 wt. % pressing additives and possibly binding agents,
Fe+1 wt. %−3 wt. % Cu+0.5 wt. %−0.9 wt. % C+0.3 wt. %−0.8 wt. % pressing additives and possibly binding agents,
Astaloy CrM (Cr+Mo prealloyed iron powder)+1 wt. %−3 wt. % Cu+0.1 wt. %−1 wt. % C+0.3 wt. %−1.0 wt. % pressing additives and possibly binding agents.

Said list of powder mixtures should not be considered to be definitive however.

The powder is pressed in a powder press into a green compact and then sintered in one or multiple steps, in particular in an inert gas atmosphere. In the powder press the green compact is given at least substantially its final form, for example as shown in FIG. 1, whereby of course various size changes caused by sintering are taken into account, provided that the sintered component 1 is not produced overall in net shape or near net shape quality. Preferably however, the sintered component is produced in net-shape or near net-shape quality. It is possible by means of the sintering method to produce the sintered component 1 in one piece.

If necessary, to increase the precision of the part the sintered component 1 can be calibrated after sintering, by pressing the sintered component 1 between two stamps, for example in a calibrating die of corresponding geometry.

It is possible for the bearing mount 10 not to be calibrated.

It is also possible for the surface of the sintered component 1 to be compacted afterwards with the exception of a surface 14 of the bearing mount 10.

After the sintering and if necessary the calibration and/or possible surface compaction of the sintered component 1 at least the surface 14 of the bearing mount 10 is hardened which comes into direct contact with the multi-layered sliding bearing element 11. The hardening can be performed for example by inductive or laser hardening, by case hardening or quenching and tempering. Hardening techniques are known from the prior art and reference is made to the latter here.

The whole sintered component 1 can also be subjected to hardening.

The bearing mount 10 is produced in near net shape or net shape quality. In this way the mechanical post-processing of the surface 14 of the bearing mount 10 with regard to its geometry is not necessary. The surface 14 of the bearing mount 10 is thus left sintered-smooth. The multi-layered sliding bearing element 11 is inserted, in particular pressed, into said sintered-smooth bearing mount 10 according to the method of the invention.

The term “sintered-smooth” is defined as the surface quality of a sintered component 1 which is obtained after sintering or after calibration and is not or has not been subjected to any further material-removing or compacting processes.

The multi-layered sliding bearing element 11 lies with the first layer 12 directly on the surface 14 of the bearing mount 19. Said first layer 12 is made in particular from a material, which gives the multi-layered sliding bearing element 11 its structural strength. For example, the first layer 12 can be made from steel, a copper-based alloy, such as e.g. bronze or brass.

The first layer 12 is harder than the second layer 13. Said second layer 13 can be made for example from a copper-based alloy, an aluminum-based alloy, a tin-based alloy, copper etc., with the proviso that the same materials are not used for the first and the second layer 12, 13.

According to one embodiment variant the sintered-smooth surface 14 of the bearing mount 10, which is in direct contact with the multi-layered sliding bearing element 11, is made to have an arithmetic average roughness value Rₐ according to DIN EN ISO 4287:2010 of at least 0.9 μm and a maximum of 2 μm, in particular at least 1 μm and a maximum of 1.8 μm.

It is possible according to another embodiment variant that the sintered-smooth surface 14 of the bearing mount 10, which is in direct contact with the multi-layered sliding bearing element 11, is made to have a surface roughness with an average roughness depth R_{z} according to DIN EN ISO 4287:2010 of at least 2 μm and a maximum of 30 μm, in particular at least 10 μm and a maximum of 20 μm.

In addition, according to another embodiment variant it is possible that the sintered-smooth surface 14 of the bearing mount 10, which is in direct contact with the multi-layered sliding bearing element 11, is made to have a surface roughness with a reduced center height Rₚₖ according to DIN EN ISO 13565:1998 and DIN ISO 23519:2015 of at least 0.1 μm and a maximum of 1.9 μm, in particular at least 0.2 μm and a maximum of 1 μm.

The said surface topographies can be produced by using a die or a core rod with a suitable surface.

It can also be advantageous according to another embodiment variant, if a multi-layered sliding bearing element 11 is pressed into the bearing mount 10, which has a surface which is in direct contact with the surface 14 of the bearing mount 10, with an average roughness depth R_{z} according to DIN EN ISO 4287:2010 of at least 2 μm and a maximum of 30 μm. A corresponding material can be used for the layer 12 which has said surface roughness. However, if necessary said surface of the first layer 12 can also be machined (mechanically) in order to provide said surface roughness.

Particularly preferably, according to another embodiment variant a material is used for the first layer 12 which comprises the same base metal with the base metal of the sintered component 1. A steel can be used as a first layer 12 for example for a sintered component 1 made from an iron-based metal powder.

FIG. 2 shows a section of a further embodiment variant of the sintered component 1. In this embodiment variant the multi-layered sliding bearing element 11, in particular the first layer 12, is provided with a lead-in chamfer 15, which is formed by a broken edge or a rounded edge.

Alternatively or additionally to this, the sintered component 1 can also be provided with such a lead-in chamfer 16 in the area of the bearing mount 10, as shown by dashed lines in FIG. 2. Said lead-in chamfer 16 can also be formed by a beveled or rounded edge.

The embodiments show or describe possible embodiment variants, wherein it should be noted at this point that combinations of the individual embodiment variants are possible.

Lastly, as a point of formality, it should be noted that to better illustrate the structure of the sintered component 1 the latter has not necessarily been drawn to scale.

### LIST OF REFERENCE NUMERALS

1 sintered component
2 main body
3 direction
4 end face
5 end face
6 direction
7 peripheral surface
8 toothing
9 toothing
10 bearing mount
11 multi-layered sliding bearing element
12 layer
13 layer
14 surface
15 lead-in chamfer
16 lead-in chamfer

1: A method for producing a toothed sintered component (1) according to which a green compact with a bearing mount (10) is pressed from a powder, the green compact is sintered and hardened and then at least one sliding bearing element is inserted into the bearing mount (10), wherein the sliding bearing element is inserted into the bearing mount (10) which has a sintered-smooth surface (14), wherein a multi-layered sliding bearing element (11) is used as the sliding bearing element.

2: The method as claimed in claim 1, wherein the sintered-smooth surface (14) of the bearing mount (10), which is in direct contact with the multi-layered sliding bearing element (11), is made to have an arithmetic average roughness value Rₐ according to DIN EN ISO 4287:2010 of at least 0.9 μm and a maximum of 2 μm.

3: The method as claimed in claim 1, wherein the sintered-smooth surface (14) of the bearing mount (10), which is in direct contact with the multi-layered sliding bearing element (11), is made to have a surface roughness with an average roughness depth R_{z} according to DIN EN ISO 4287:2010 of at least 2 μm and a maximum of 30 μm.

4: The method as claimed in claim 1, wherein the sintered-smooth surface (14) of the bearing mount (10), which is in direct contact with the multi-layered sliding bearing element (11), is made to have a surface roughness having a reduced center height Rₚₖ according to DIN EN ISO 13565:1998 and DIN ISO 23519:2015 of at least 0.1 μm and a maximum of 1.9 μm.

5: The method as claimed in claim 1, wherein a multi-layered sliding bearing element (11) is pressed in, which has a surface, which is in direct contact with the surface (14) of the bearing mount (10), with an average roughness depth R_{z} according to DIN EN ISO 4287:2010 of at least 2 μm and a maximum of 30 μm.

6: The method as claimed in claim 1, wherein the sintered component (1) and a layer (12) of the multi-layered sliding bearing element (11), which is in direct contact with the sintered-smooth surface (14) of the bearing mount (10), are made from a metal material with the same base metal.

7: A sintered component (1) comprising a main body (2), which has a toothing (8, 9) and a bearing mount (10), with at least one sliding bearing element arranged in the bearing mount (10), wherein the bearing mount (10) has a sintered-smooth surface (14) and the sliding bearing element is a multi-layered sliding bearing element (11).

8: The sintered component (1) as claimed in claim 7, wherein the multi-layered sliding bearing element (11) and/or the bearing mount (10) comprise(s) a lead-in chamfer (15, 16).
